(19) United States
(12) Patent Application Publication
(10) Pub. No.: US 2022/0398543 A1
(43) Pub. Date: Dec. 15, 2022

(54) SCHEDULING LANGUAGE AND MODEL FOR APPOINTMENT EXTRACTION

(71) Applicant: Aktify, Inc., Lehi, UT (US)

(72) Inventors: Amir Ali Abdullah, Provo, UT (US); Jason Feriante, Bluffdale, UT (US); Cassandra Darley, Cedar Hills, UT (US); Joe Hawkins, Bluffdale, UT (US); Kreg Peeler, Draper, UT (US)

(21) Appl. No.: 17/346,032

(22) Filed: Jun. 11, 2021

(51) Int. Cl. G06Q 10/10; G06F 40/274; G06F 40/284; G06F 40/205

(52) U.S. Cl. CPC G06Q 10/1095; G06F 40/274; G06F 40/284; G06F 40/205

(57) ABSTRACT

A lead management system can employ a scheduling language and model for extracting appointments from consumer interactions. By using a scheduling language and model, the lead management system can accurately determine from textual content a particular time at which a consumer agreed to be called or to otherwise participate in an appointment with a representative of a business. As a result, AI-based consumer interaction agents can be utilized much more effectively to revive dead leads.

### CROSS-REFERENCE TO RELATED APPLICATIONS

N/A

### BACKGROUND

A lead can be considered a contact, such as an individual or an organization, that has expressed interest in a product or service that a business offers. A lead could merely be contact information such as an email address or phone number, but may also include an individual's name, address or other personal/organization information, an identification of how an individual expressed interest (e.g., providing contact/personal information via a web-based form, signing up to receive periodic emails, calling a sales number, attending an event, etc.), communications the business may have had with the individual, etc. A business may generate leads itself (e.g., as it interacts with potential customers) or may obtain leads from other sources.

A business may use leads as part of a marketing or sales campaign to create new business. For example, sales representatives may use leads to contact individuals to see if the individuals are interested in purchasing any product or service that the business offers. These sales representatives may consider whatever information a lead includes to develop a strategy that may convince the individual to purchase the business's products or services. When such efforts are unproductive, a lead may be considered dead. Businesses typically accumulate a large number of dead leads over time.

Recently, efforts have been made to employ artificial intelligence to identify leads that are most likely to produce successful results. For example, some solutions may consider the information contained in leads to identify which leads exhibit characteristics of the ideal candidate for purchasing a business's products or services. In other words, such solutions would inform sales representatives which leads to prioritize, and then the sales representatives would use their own strategies to attempt to communicate with the respective individuals.

### BRIEF SUMMARY

The present invention extends to a lead management system that employs a scheduling language and model for appointment extraction and to systems, methods and computer program products for extracting appointments from consumer interactions using the scheduling language and model. By using a scheduling language and model, a lead management system can accurately determine, from textual content of a consumer interaction, a particular time at which a consumer agreed to be called or to otherwise participate in an appointment with a representative of a business. As a result, AI-based consumer interaction agents can be utilized much more effectively to revive dead leads.

In some embodiments, the present invention may be implemented as a method for using a scheduling language and model to extract an appointment from a consumer interaction. A consumer interaction that includes textual content can be received. Tokens of the scheduling language that are included in the textual content of the consumer interaction can be identified. It can then be determined that the tokens of the scheduling language that are included in the textual content of the consumer interaction match a first pattern of the scheduling language. A scheduling directive matching the first pattern can then be generated for the consumer interaction.

In some embodiments, the present invention may be implemented as computer storage media storing computer executable instructions which when executed implement a method for extracting an appointment from a consumer interaction. This method may include: receiving a consumer interaction that includes textual content; converting the textual content included in the consumer interaction to a scheduling directive using a scheduling language and model; creating, from the scheduling directive, code objects conforming to a scheduling specification; and generating one or more appointment timestamps from the code objects.

In some embodiments, the present invention may be implemented as a lead management system that includes one or more processors and computer storage media storing computer executable instructions which when executed implement a business appointment extractor that is configured to extract an appointment from a consumer interaction. The business appointment extractor can receive a text message that a consumer sent to a consumer interaction agent. The business appointment extractor can convert the text message into a scheduling directive using a scheduling language and model. The business appointment extractor can generate an appointment timestamp based on the scheduling directive.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which one or more embodiments of the present invention may be implemented;

FIG. 2 provides an example of various components that a lead management system may include in accordance with one or more embodiments of the present invention;

FIG. 3 provides an example of a lead data structure by which a lead may be represented in a lead management system in accordance with one or more embodiments of the present invention;

FIG. 4 provides an example of consumer interactions that a consumer interaction agent may have with a consumer in accordance with one or more embodiments of the present invention;

FIG. 5 provides an example of various aspects of a scheduling language that may be employed in one or more embodiments of the present invention;

FIG. 6 provides an example of how a business appointment extractor of a lead management system may be configured in one or more embodiments of the present invention; and

FIGS. 7A-7D provide an example of how a scheduling language and model can be used to generate an appointment timestamp from a consumer interaction in accordance with one or more embodiments of the present invention.

### DETAILED DESCRIPTION

In the specification and the claims, the term “consumer” should be construed as an individual. A consumer may or may not be associated with an organization. The term “lead” should be construed as information about, or that is associated with, a particular consumer. The term “consumer computing device” can represent any computing device that a consumer may use and by which a lead management system may communicate with the consumer. In a typical example, a consumer computing device may be a consumer's phone.

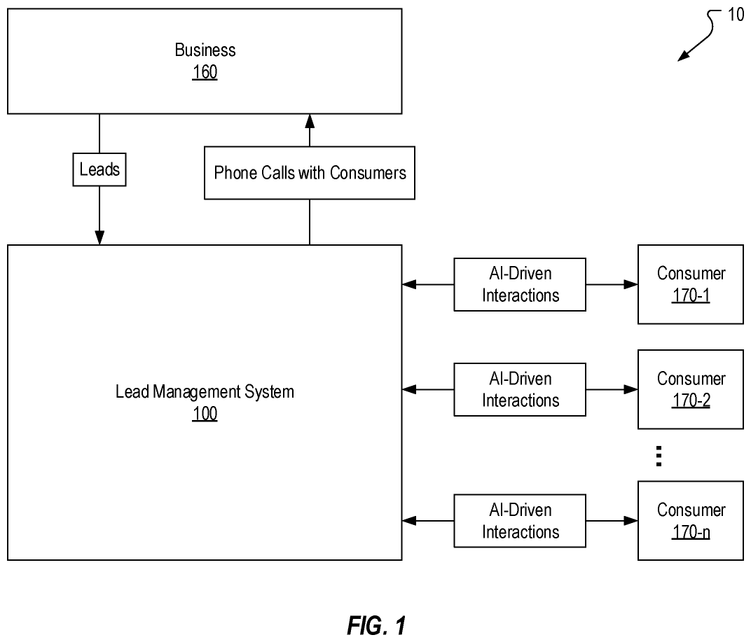

FIG. 1 provides an example of a computing environment 10 in which embodiments of the present invention may be implemented. Computing environment 10 may include a lead management system 100, a business 160 and consumers 170-1 through 170-n (or consumer(s) 170). As shown, business 160 can provide leads to lead management system 100 where the leads can correspond with consumers 170. Typically, these leads may be dead leads that business 160 has accumulated, but any type of lead may be provided in embodiments of the present invention. Although only a single business 160 is shown, there may typically be many businesses 160.

Lead management system 100 can perform a variety of functionality on the leads to enable lead management system 100 to have AI-driven interactions with consumers 170. For example, these AI-driven interactions can be text messages that are intended to convince consumers 170 to have a phone call with a sales representative of business 160. Once the AI-driven interactions with a particular consumer 170 are successful (e.g., when the particular consumer 170 agrees to a phone call with business 160), lead management system 100 may initiate/connect a phone call between the particular consumer 170 and a sales representative of business 160. Accordingly, by only providing its leads, including its dead leads, to lead management system 100, business 160 can obtain phone calls with consumers 170.

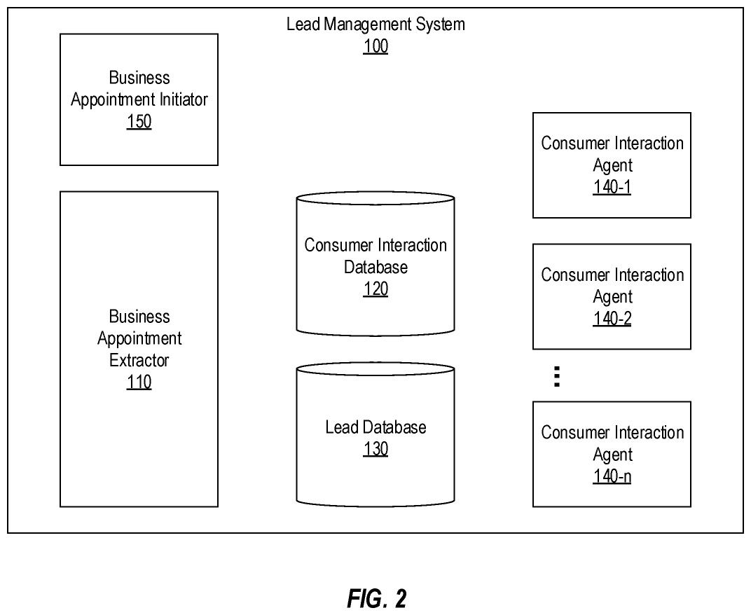

FIG. 2 provides an example of various components that lead management system 100 may include in one or more embodiments of the present invention. These components may include a business appointment extractor 110, a consumer interaction database 120, a lead database 130, consumer interaction agents 140-1 through 140-n (or consumer interaction agent(s) 140) and a business appointment initiator 150.

Business appointment extractor 110 can represent one or more components of lead management system 100 that implement a scheduling language and model for extracting appointments from consumer interactions. Consumer interaction database 120 can represent one or more data storage mechanisms for storing consumer interactions or data structures defining consumer interactions. Lead database 130 can represent one or more data storage mechanisms for storing leads or data structures defining leads.

Consumer interaction agents 140 can be configured to interact with consumers 170 via consumer computing devices. For example, consumer interaction agents 140 can communicate with consumers 170 via text messages, emails or another text-based mechanism. These interactions, such as text messages, can be stored in consumer interaction database 120 and associated with the respective consumer 170 (e.g., via associations with the corresponding lead defined in lead database 130).

Business appointment initiator 150 can represent one or more components of lead management system 100 that are configured to initiate an appointment (e.g., a phone call or similar communication) between a consumer 170 and a representative of business 160. For example, business appointment initiator 150 could establish a call with a consumer and then connect the business representative to the call. In accordance with embodiments of the present invention, business appointment extractor 110 can intelligently select the timing of such appointments by applying a scheduling language and model to the consumer interactions that consumer interaction agents 140 have with consumers 170.

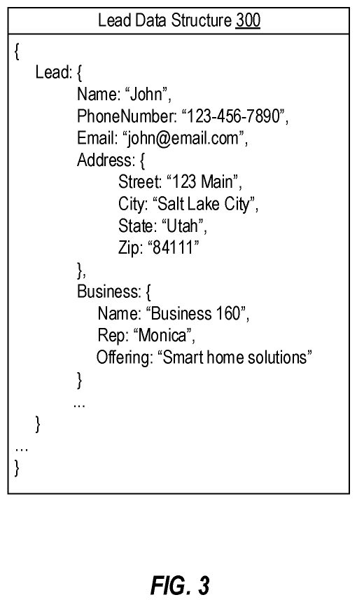

FIG. 3 provides a simplified example of a lead data structure 300 that may be used in one or more embodiments of the present invention to define a lead. Although lead data structure 300 represents that a lead is defined with a single data structure, any number and/or arrangement of data structures could be used to define a lead within lead management system 100.

As shown, lead data structure 300 can define an association between a consumer and a business from which the lead was obtained or with which the lead is otherwise associated. For example, lead data structure 300 defines a number of consumer elements such as the consumer's name (John), phone number (123-456-7890), email address (john@email.com) and address (123 Main, Salt Lake City, Utah 84111) and defines a number of business elements such as the business's name/identifier (Business 160), a name of any representative(s) of the business that has/have contacted the associated consumer (Monica) and any offering(s) of the business in which the associated consumer expressed interest (Smart home solutions). A lead data structure 300 need not include all these consumer and business elements and could include many other consumer and/or business elements. For example, lead data structure 300 can be initially populated with whatever consumer and business elements the business has provided for the lead and can be modified to include or be associated with additional AI-calculated elements that consumer interaction agents 140 can use to dynamically generate the interactions with the consumers.

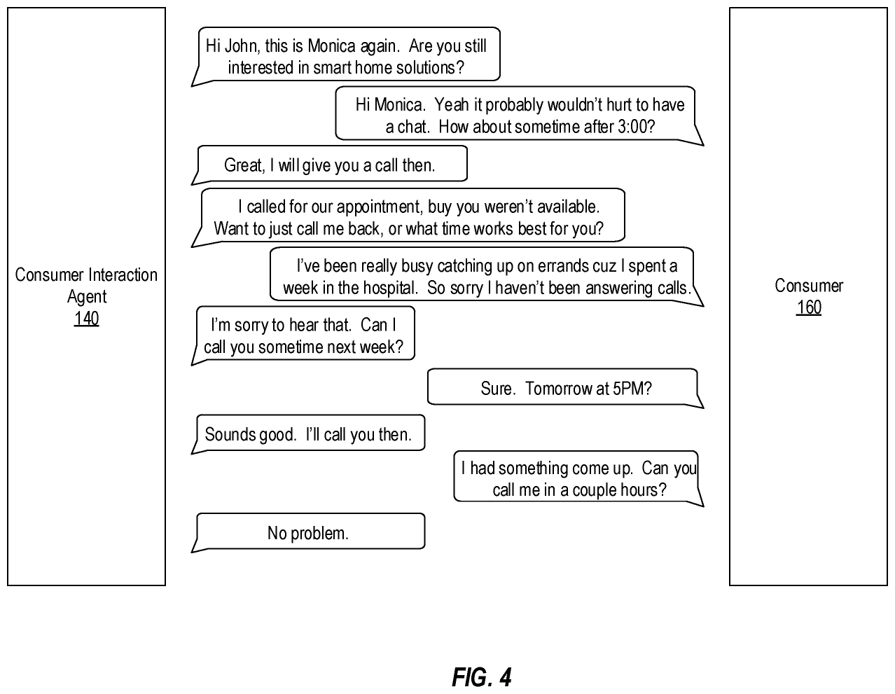

FIG. 4 provides an example of how a consumer interaction agent 140 can interact with a consumer 170. Consumer interaction agent 140 could use the content of lead data structure 300 to generate these interactions. Of primary relevance to embodiments of the present invention, the depicted interactions include a number of interactions that discuss scheduling of an appointment. For example, the consumer (John) states: “How about sometime after 3:00?” “Tomorrow at 5 PM?” and “Can you call me in a couple hours?” Business appointment extractor 110 can be configured to process such interactions that discuss scheduling using a scheduling language and model to convert them (or more particularly, to convert the textual content relating to the scheduling of an appointment) into an explicit, unambiguous scheduling directive.

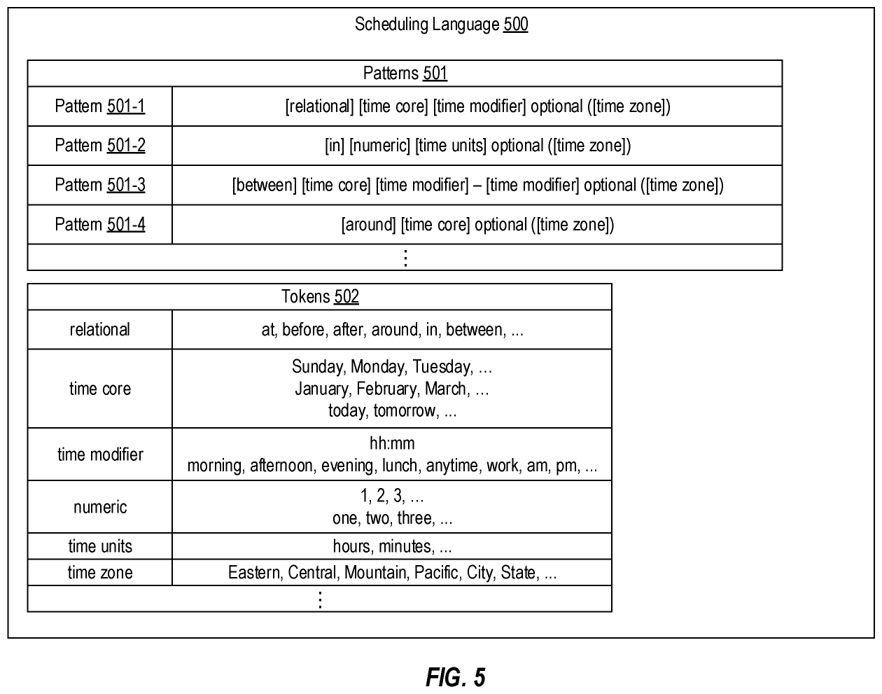

FIG. 5 provides an example of various patterns 501 of a scheduling language 500 that business appointment extractor 110 may use in one or more embodiments of the present invention. As an overview, when processing a consumer interaction, business appointment extractor 110 can use natural language processing and machine learning techniques to determine whether the consumer interaction matches any of patterns 501 and, if so, can create an unambiguous scheduling directive defining when business appointment initiator 150 should attempt to initiate an appointment with the consumer. For purposes of this description and the claims, an appointment may be a phone call or other live communication between a consumer and a representative of a business.

Patterns 501 are defined using a sequence of tokens 502 representing words, phrases or other content that may appear in consumer interactions. As an example, tokens 502 may include relational tokens (e.g., the words “at,” “before,” “after,” “around,” “in,” “between,” etc.), time core tokens (e.g., the days of the week, the months of the year, “today,” “tomorrow,” words or phrases from which today, tomorrow, am, pm, etc. can be inferred from context, the word “next,” etc.), time modifier tokens (e.g., a specified time, the words “morning,” “afternoon,” “evening,” “lunch,” “anytime,” “work,” etc.), numeric tokens (e.g., any number in numeric or textual form), time unit tokens (e.g., “hours,” “minutes,” etc.), time zone tokens (e.g., a specific time zone or a city, state, etc. form which the time zone can be inferred), punctuation tokens (not shown), etc.

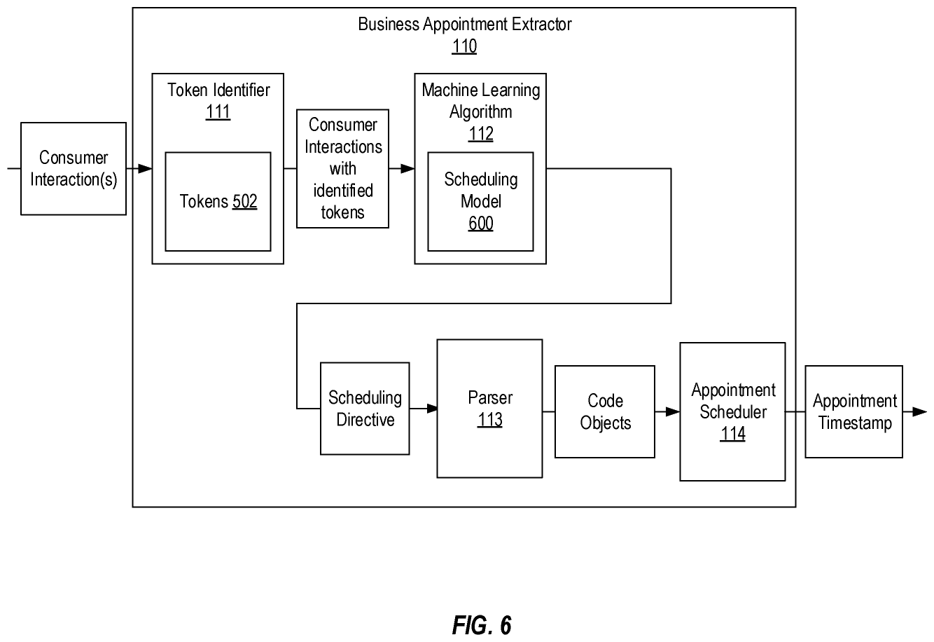

Scheduling language 500, and particularly patterns 501 and tokens 502, can be applied to previous consumer interactions or other data sets for use in training a scheduling model 600 of a machine learning algorithm 112 (see FIG. 6). In other words, scheduling model 600 can be trained to intelligently determine, using scheduling language 500, a particular time or range of times for an appointment based on the content of one or more interactions a consumer 170 had with a consumer interaction agent 140.

In some embodiments, pattern 501 could be used to determine when a consumer interaction specifies an exact time for an appointment. In some embodiments, pattern 502 could be used to determine when a consumer interaction specifies a relative time for an appointment. In some embodiments, pattern 503 could be used to determine when a consumer interaction specifies a range of times for an appointment. In some embodiments, pattern 504 could be used to determine when a consumer interaction specifies a day without any specific time, relative time or range of time. Scheduling language 500 could also include other patterns including variations or patterns 501-504.

FIG. 6 provides an example of various components business appointment extractor 110 may have to enable it to convert consumer interactions into appointment timestamps. These components may include a token identifier 111 which can represent the portion of business appointment extractor 110 that identifies the occurrence of tokens 502 in a consumer interaction (or set of consumer interactions). In other words, token identifier 111 can receive the textual content of one or more interactions a particular consumer has had with a consumer interaction agent 140 and can parse the interaction(s) to identify/tag token(s) 502 appearing therein. The consumer interaction(s) with the identified tokens 502 can then be provided to a machine learning algorithm 112 that can apply scheduling model 600 to convert the textual content of the consumer interaction(s) into a scheduling directive. A scheduling directive can be in the form of textual content that conforms to one of patterns 501. In other words, machine learning algorithm 112 can determine which of patterns 501 the textual content of the consumer interaction(s) matches, if any, and can then convert the textual content to the form dictated by the matching pattern 501. A parser 113 can receive a scheduling directive and convert it into code objects conforming to a scheduling specification. Finally, an appointment scheduler 114 can receive the code objects conforming to the scheduling specification and generate an appointment timestamp or range of timestamps representing a specific time when business appointment initiator 150 should attempt to establish an appointment (e.g., a phone call) between the respective business 160 and consumer 170.

In some embodiments, the scheduling specification can include a day specification object (DaySpec) which unambiguously identifies a particular day, a date specification object (DateSpec) which unambiguously identifies a particular date, a time specification object (TimeSpec) which unambiguously identifies a particular time, a duration specification object (DurationSpec) which unambiguously identifies a particular duration of time, a time zone specification object (TimeZoneSpec) which unambiguously identifies a particular time zone, etc. The code objects generated for any particular scheduling directive may only include/define some of these objects of the scheduling specification.

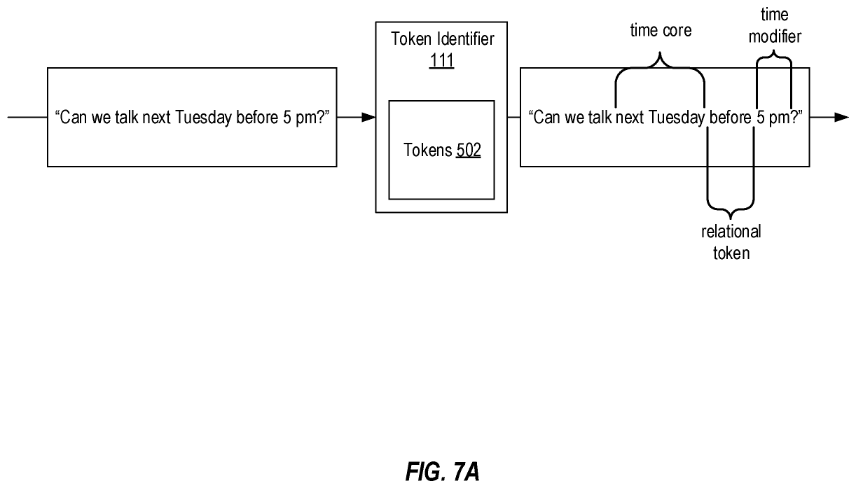

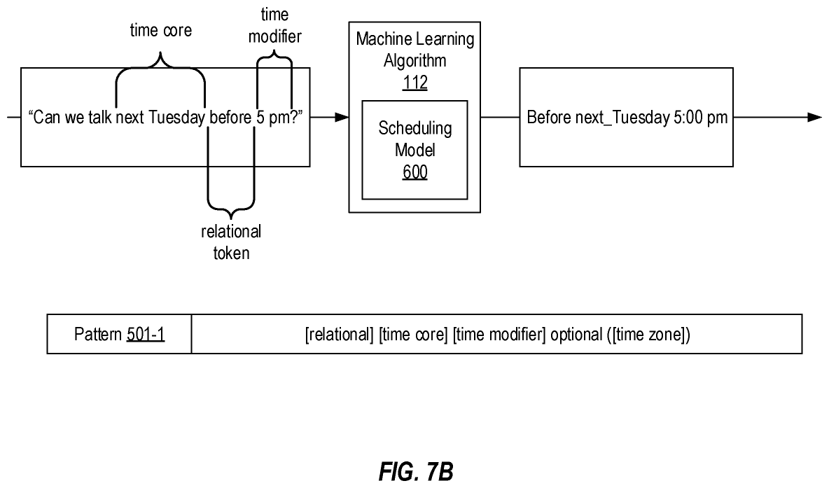

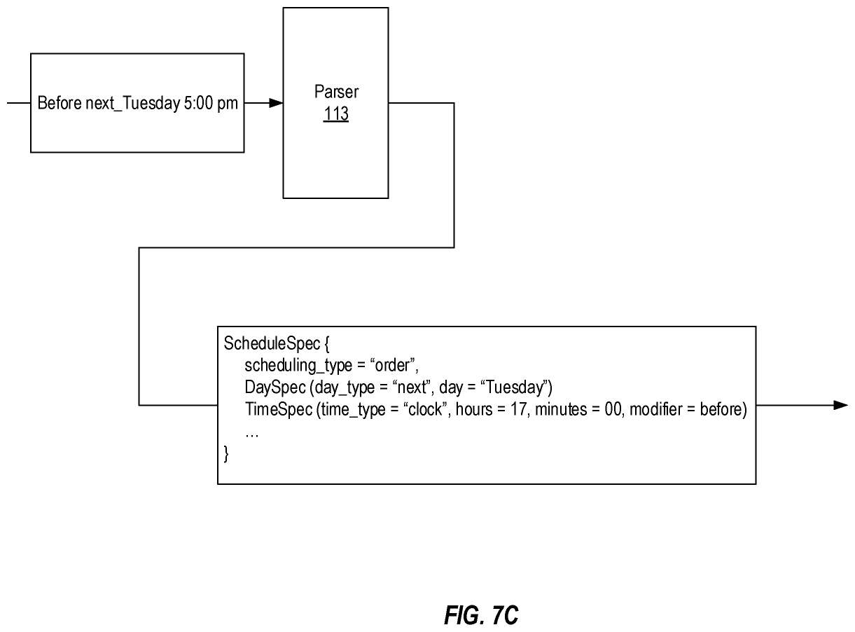

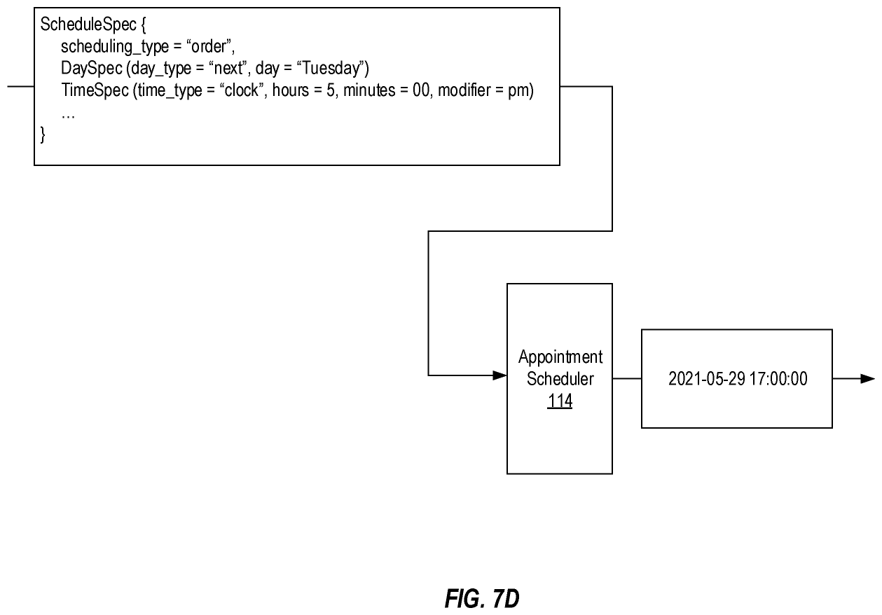

FIG. 7A-7D provide an example of how business appointment extractor 110 may generate an appointment timestamp from a consumer interaction using scheduling language 500 and scheduling model 600. In this example, the consumer interaction includes textual content of “Can we talk next Tuesday before 5 pm?” As shown in FIG. 7A, token identifier 111 can identify that this textual content includes a time core token (next Tuesday), a relational token (before) and a time modifier token (5 pm).

Turning to FIG. 7B, with these tokens identified in the consumer interaction, machine learning algorithm 112 can employ scheduling model 600 to convert the textual content of the consumer interaction into a scheduling directive. In this example, scheduling model 600 could identify the relational token, the time core token and the time modifier token, determine that the presence of these tokens matches pattern 501-1 and create a scheduling directive of “Before next Tuesday 5 pm” which matches pattern 501-1.

Turning to FIG. 7C, a parser 113 can receive the scheduling directive and generate code objects conforming to the scheduling specification. For example, where this scheduling directive identifies a particular day (next_Tuesday), parser 113 can create a DaySpec object having a day_type property set to “next” and a day property set to “Tuesday.” Also, where this scheduling directive identifies a particular time (before 5:00 pm), parser 113 can create a TimeSpec object having a time-type property set to “clock,” an hours property set to “17,” a minutes property set to “00” and a modifier property set to “before.” In contrast, if the scheduling directive had specified a specific date, parser 113 could have created a DateSpec object having properties identifying the particular date.

Turning to FIG. 7D, appointment scheduler 114 can receive the code objects that parser 113 generates from the scheduling directive and can generate one or more appointment timestamps defining absolute times when a call should be attempted with the consumer. Because of the scheduling specification, appointment scheduler 114 may generate these appointment timestamps as absolute timestamps that are likely to match the consumer's intent. In this case, appointment scheduler 113 could generate the appointment timestamp of 2021 Jun. 1 16:45:00. In generating this appointment timestamp, appointment scheduler 114 may use a date or time when the consumer interaction occurred (e.g., to determine what date “next Tuesday” is), a time zone token, if available, other context (e.g., any information that AI-techniques could consume to identify a particular time before 5:00 pm when the consumer may be most likely to answer), etc.

In some embodiments, appointment scheduler 113 may employ information about business 160 in generated an appointment timestamp. For example, appointment scheduler 113 could determine when a representative of business 160 may be available including when a particular representative may be available (e.g., the particular representative's work schedule) or when any representative may be available (e.g., when business 160's call center is open).

Other examples include: converting the textual content “I am busy right now. Can you call me in 2 hours please?” into a scheduling directive of “In 2 hours” in accordance with pattern 501-2; converting the textual content “Can we chat tomorrow morning at 9:30?” into a scheduling directive of “At tomorrow 9:30 am_inf” in accordance with pattern 501-1 where “am_inf” is a time modifier token that is inferred from context; converting the textual content “I'm available between 7 and 9 pm this evening” into a scheduling directive of “between today_inf 7:00 pm-9:00 pm” in accordance with pattern 501-3 where “today_inf” is a time core token inferred from context; and converting the textual content “Call me on Saturday” into a scheduling directive of “around Saturday” in accordance with pattern 501-4.

In some cases, textual content may include tokens 502 matching multiple patterns 501. In such cases, scheduling model 600 may generate multiple scheduling directives and could use AI techniques and/or context of the consumer interactions to rank or prioritize a particular scheduling directive.

The above-described process could be performed after a consumer interaction agent 140 has communicated with a consumer 160 or while a consumer interaction agent 140 is communicating with a consumer 160. For example, in some embodiments, as a consumer interaction agent 140 is communicating with a consumer 160, business appointment extractor 110 could process the consumer interactions as they occur to detect when a consumer interaction may include scheduling content. In such cases, business appointment extractor 110 could generate an appointment timestamp in real-time such as when the scheduling directive indicates that the consumer has agreed to immediately receive a phone call.

Once an appointment timestamp has been generated for a particular consumer 170, the appointment timestamp can be provided to business appointment initiator 150 which in turn can initiate a phone call or other type of appointment with consumer 170. If consumer 170 answers, business appointment initiator 150 may connect a representative of the corresponding business 160.

In some embodiments, consumer interaction agents 140 may receive and use appointment timestamps as part of the consumer interaction process. For example, as a consumer interaction agent 140 interacts with a consumer, business appointment extractor 110 may generate, from the consumer interactions, one or more appointment timestamps that consumer interaction agent 140 can use to attempt to schedule an appointment at a particular time. Using a similar example as in FIGS. 7A-7D, appointment scheduler 114 could produce one or more appointment timestamps for times before 5:00 pm on next Tuesday (e.g., at 4:00 pm, 4:45 pm, 4:50 pm, etc.). In such a case, consumer interaction agent 140 could present the time(s) to the consumer to attempt to confirm a specific time for an appointment. Once the consumer confirms a particular time, the corresponding appointment timestamp can be used to initiate the appointment at the particular time.

In summary, a lead management system can employ a scheduling language and model for extracting appointments from consumer interactions. By using a scheduling language and model, the lead management system can accurately determine from textual content a particular time at which a consumer agreed to be called or to otherwise participate in an appointment with a representative of a business. As a result, AI-based consumer interaction agents can be utilized much more effectively to revive dead leads.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for using a scheduling language and model to extract an appointment from a consumer interaction, the method comprising:
receiving a consumer interaction that includes textual content;
identifying tokens of the scheduling language that are included in the textual content of the consumer interaction;
determining that the tokens of the scheduling language that are included in the textual content of the consumer interaction match a first pattern of the scheduling language; and
generating a scheduling directive for the consumer interaction, the scheduling directive matching the first pattern.

2. The method of claim 1, further comprising:
creating, from the scheduling directive, code objects conforming with a scheduling specification.

3. The method of claim 2, further comprising:
creating, from the code objects, one or more appointment timestamps.

4. The method of claim 3, further comprising:
initiating an appointment with the consumer in accordance with one of the one or more appointment timestamps.

5. The method of claim 1, wherein the consumer interaction comprises one or more text messages.

6. The method of claim 1, wherein the tokens of the scheduling language comprise one or more of:
relational tokens;
time core tokens;
time modifier tokens;
numeric tokens;
time units tokens; or
time zone tokens.

7. The method of claim 1, wherein the first pattern comprises two or more tokens.

8. The method of claim 1, wherein the first pattern comprises three or more tokens.

9. The method of claim 1, wherein generating the scheduling directive for the consumer interaction comprises applying the model to the textual content of the consumer interaction.

10. The method of claim 1, wherein the scheduling directive comprises a portion of the textual content of the consumer interaction.

11. One or more computer storage media storing computer executable instructions which when executed implement a method for extracting an appointment from a consumer interaction, the method comprising:
receiving a consumer interaction that includes textual content;
converting the textual content included in the consumer interaction to a scheduling directive using a scheduling language and model;
creating, from the scheduling directive, code objects conforming to a scheduling specification; and
generating one or more appointment timestamps from the code objects.

12. The computer storage media of claim 11, wherein converting the textual content included in the consumer interaction to the scheduling directive using the scheduling language and model comprises identifying tokens of the scheduling language that are included in the textual content of the consumer interaction.

13. The computer storage media of claim 11, wherein converting the textual content included in the consumer interaction to the scheduling directive using the scheduling language and model comprises determining that the tokens of the scheduling language that are included in the textual content of the consumer interaction match a first pattern of the scheduling language.

14. The computer storage media of claim 11, wherein the scheduling language includes one or more of:
relational tokens;
time core tokens;
time modifier tokens;
numeric tokens;
time units tokens; or
time zone tokens.

15. The computer storage media of claim 11, wherein the method further comprises:
using one of the one or more appointment timestamps to confirm an appointment with the consumer.

16. The computer storage media of claim 11, wherein the method further comprises:
initiating an appointment between the consumer and a representative of a business in accordance with one of the one or more appointment timestamps.

17. The computer storage media of claim 16, wherein the appointment is a phone call.

18. The computer storage media of claim 11, wherein the consumer interaction comprises one or more text messages.

19. A lead management system comprising:
one or more processors; and
computer storage media storing computer executable instructions which when executed implement a business appointment extractor that is configured to extract an appointment from a consumer interaction by performing a method comprising:
receiving a text message that a consumer sent to a consumer interaction agent;
converting the text message into a scheduling directive using a scheduling language and model; and
generating an appointment timestamp based on the scheduling directive.

20. The lead management system of claim 19, wherein generating an appointment timestamp based on the scheduling directive comprises:
creating, from the scheduling directive, code objects conforming to a scheduling specification; and
generating the appointment timestamp from the code objects.
